(19) United States
(12) Patent Application Publication
(10) Pub. No.: US 2023/0004565 A1
(43) Pub. Date: Jan. 5, 2023

(54) A CACHE UPDATING SYSTEM AND A METHOD THEREOF

(71) Applicant: Loodos Bilisim Teknolojileri San. Ve Tic. Ltd. Sti., Sariyer/lstanbul (TR)

(72) Inventors: Emrah CETINER, Sariyer/lstanbul (TR); Kaan ERDEMIR, Sariyer/lstanbul (TR)

(73) Assignee: Loodos Bilisim Teknolojileri San. Ve Tic. Ltd. Sti., Sariyer/lstanbul (TR)

(21) Appl. No.: 17/781,495

(22) PCT Filed: Jun. 3, 2021
(86) PCT No.: PCT/TR2021/050532

§ 371 Date: Jun. 1, 2022

(30) Foreign Application Priority Data
Jun. 25, 2020 (TR) 2020/09944

(51) Int. Cl. G06F 16/2455; G06F 16/957

(52) U.S. Cl. CPC G06F 16/24552; G06F 16/9574

(57) ABSTRACT

The present invention relates to an asynchronous cache updating system and a method thereof, wherein the problems of repeatedly retrieving data from the main data source as data in cache systems is deleted after a certain period of time and being able to retrieve cached data only in the second and the subsequent requests are eliminated. The present invention particularly relates to a cache updating system and a method thereof that allows for changing cached data over time without using it and without expecting a request from the user and for updating data stored on the cache systems independently of the validity period of the data.

### TECHNICAL FIELD OF THE INVENTION

The present invention relates to an asynchronous cache updating system and a method thereof, wherein the problems of repeatedly retrieving data from the main data source as data in cache systems are deleted after a certain period of time and being able to retrieve cached data only in the second and the subsequent requests are eliminated.

The present invention particularly relates to a cache updating system and a method thereof that allows for changing cached data over time without using it and without expecting a request from the user and for updating data stored on cache systems independently of the validity period of the data.

### STATE OF THE ART

A cache is a high-speed data storage layer that stores a temporary data subset. In other words, a cache refers to temporarily storing a web page loaded in a browser or an application and data to be retrieved from the Internet. Thus, less bandwidth is used, and fewer requests are sent to the server when the said web page is visited once again. This improves the user experience.

Data in a cache is usually stored in hardware such as Random-Access Memory (RAM) and may require establishing a connection over software in order to access data. There are two types of caches in general. Those are server-side caching and browser-side caching.

Browser-side caching is performed when you try to load a website twice. The respective website collects data in order to load the page on your first try. After downloading the data, the browser serves as temporary storage in order to keep the data. Server-side caching is very similar to browser-side caching. The difference between these two is that the server is temporary storage. A server-side cache is capable of storing more data.

There are many cache systems available since server-side caching uses a server to store the web browser. Said systems may be categorized as full-page caching, object caching, and fragment caching.

Data kept in cache systems is a copy of the original data. Therefore, it will be an invalid piece of information when the data is changed on the main source. In that case, the program utilizing the respective data on the cache will end up performing wrong operations if the corresponding data is not updated.

For this problem, cached data gets deleted after a certain period of time and the respective data must be retrieved once again from the main data source. Consequently, a validity period is determined for the cached data. The existence of validity periods in caching systems ensures that said systems are refreshed at specific intervals.

In addition, cache systems are developed with an architecture that will be formed by data requests of end-users over sources. In other words, a caching system does not contain any data in the beginning. However, when a user requests data, the system reads the corresponding data from the main source and saves it to the caching system. A high-performance response is offered by reading the corresponding data from the caching system only in the second and the subsequent requests. This occurs repeatedly when the validity period of the cached data is expired.

The patent document numbered “TR2020/03451” was examined as a result of the preliminary search conducted in the state of the art. The abstract of the said invention described in the aforementioned patent application discloses; “ Method for providing a content part of a multimedia content to a client terminal, corresponding cache. According to the invention, the method for providing a content part of multimedia content to a client terminal, one or more caches being arranged along the transmission path between the client terminal and a remote server, several representations of the said content part being available, comprises:—receiving (S0) at the first cache (R), from the client terminal, a request for a given representation of the said content part belonging to a set of allowable representations selected among said available representations of the content part, said request further comprising a list of alternative representations of the set and auxiliary information for specifying the scope of the request;—checking (S1) at the said first cache (R) if said given representation is stored in the cache;—in case the said given representation is not cached, browsing (S2) at the said first cache (R) alternative representations listed.”

The patent document numbered “TR 2014/11526” was examined as a result of the preliminary search conducted in the state of the art. The abstract of the said invention that is described in the aforementioned patent application discloses; A system and method for management and processing of resource requests at cache server computing devices are provided. Cache server computing devices segment content into an initialization fragment for storage in memory and one or more remaining fragments for storage in a media having higher latency than the memory. Upon receipt of a request for the content, a cache server computing device transmits the initialization fragment from the memory, retrieves the one or more remaining fragments, and transmits the one or more remaining fragments without retaining the one or more remaining fragments in the memory for subsequent processing.”

The patent document numbered “US20190220530A1” was examined as a result of the preliminary search conducted in the state of the art. The invention described in the said patent application discloses a computer software media that is developed for asynchronously tracking the changes in web or database objects for the client-side web caching by using an application server. Said invention provides asynchronous cache management in order to reduce the network overhead caused by the increase in the number of users.

The patent document numbered “CA2664270A1” was examined as a result of the preliminary search conducted in the state of the art. The invention described in the aforementioned application discloses a method for managing networks wherein the said method allows asynchronous transmission of the data content and optimization of the network for the content transmissions that are initiated within a limited period of time. Said invention reduces the asynchronous delivery of the data content, e.g. mobile TV content, asynchronous sample, or the number of transmissions of the data content, and optimizes the network for the content transmissions that are initiated within a limited period of time. While the synchronized transmission is stored in the cache in the said method, it is stated that this must be consumed first.

The patent document numbered “US10523746B2” was examined as a result of the preliminary search conducted in the state of the art. The invention described in said patent application discloses a system and method that supports the coexistence of an asynchronous architecture and a synchronous architecture in the same server. Said invention comprises an application programming interface (API) that enables each thread in the keep-alive subsystem on the server to manage multiple connections simultaneously.

The patent document numbered “US9674258B2” was examined as a result of the preliminary search conducted in the state of the art. The invention described in said patent application discloses a system and method developed for optimizing websites. In said invention, the TPS achieves a significant reduction in the number of resources requested and the amount of the bytes needed for each resource, as the optimizer configures the optimization settings and applies settings to redirect HTTP requests and responses.

The patent document numbered “US8689052B2” was examined as a result of the preliminary search conducted in the state of the art. The invention described in said patent application discloses a system that enables an asynchronous operation to a database of the online services system or a server by providing a framework or infrastructure that allows for the development of an application to test the functionality of an application. The method disclosed in the said invention enables an asynchronous operation call or send requests to a database or a database server of the online services system by providing a framework or infrastructure that allows for the development of a software application to test the functionality of another software application.

In the caching systems used in the state of the art, the major disadvantage in platforms visited by users over the Internet is the insufficiency of the available hardware and software resources.

In cache systems used in the state of the art, operations cannot be performed without expecting a request from the user. Cached data is retrieved only after receiving a trigger request from the user.

In the caching methods used in the state of the art, updating is performed depending on the validity period of the data kept at the caching systems.

In the caching systems used in the state of the art, addressing is performed by using unique keys in order to access the correct data since accessing cached data more than once may be required.

Consequently, the aforementioned disadvantages, as well as the inadequacy of the available solutions in this regard necessitated making an improvement in the relevant technical field.

### OBJECTS OF THE INVENTION

The most important object of the present invention is to provide a solution to problems in which data is required to be retrieved from the main data source as the data in cache systems is deleted after a certain period of time, and cached data may be retrieved in the second and the subsequent requests only.

Another object of the present invention is to ensure that the data kept on the cache systems may be updated independently of the validity period of the data by means of the asynchronous cache updating feature.

Another object of the present invention is to ensure that the data on the cache system may be retrieved from the main source and updated when the system resources are consumed. Thus, the data of users that is changed on the main source can remain up-to-date all the time on the cache systems.

Yet another object of the present invention is to ensure that the data on the cache system may be created without the user request and may be read in the first request of the user rather than the second and the subsequent requests since the data is updateable and to ensure that the data can be responded to the user with high performance.

Yet another object of the present invention is to ensure that users may get a quick response and use the applications faster since end-users can receive the data over the cache system at the initial request they made.

Yet another object of the present invention is to ensure that the traffic to the servers in which the main data is stored, is controlled in a better way.

Yet another object of the present invention is to ensure that the servers may be run by using less hardware since the system resources on servers are utilized to update the cached data even when the system resources are not available for such task.

Another object of the present invention is to manage the process of requesting and receiving a single piece of data (temporal) asynchronously.

Another object of the present invention is to ensure that asynchronous caching may be performed by means of software architecture without the users visiting.

Another object of the present invention is to ensure that the server provides efficient service by means of shifting the operations to be performed when the server is too busy to a period of time when the said server is free.

Another object of the present invention is to perform the asynchronous operation requests automatically based on the user behaviour predictions.

Another object of the invention is to ensure that operations may be performed over a single system owing to the fact that evaluating the target application performance is not required.

Structural and characteristic features and all advantages of the present invention will be understood more clearly by means of the figures given below and the detailed description written by referring to those figures. Therefore, the evaluation should be conducted by taking those figures and the detailed description into consideration.

### DESCRIPTION OF THE FIGURES

FIG. 1; illustrates the elements of the inventive cache updating system.

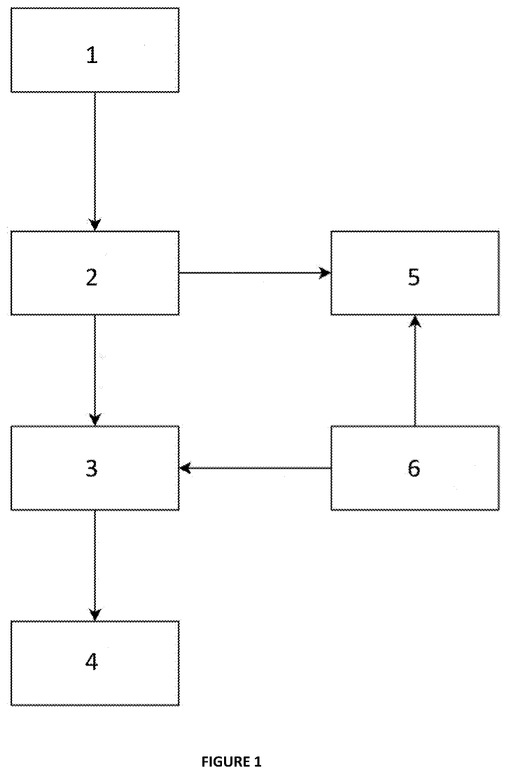

FIG. 2; illustrates the flow chart of the operation method of the inventive cache updating system.

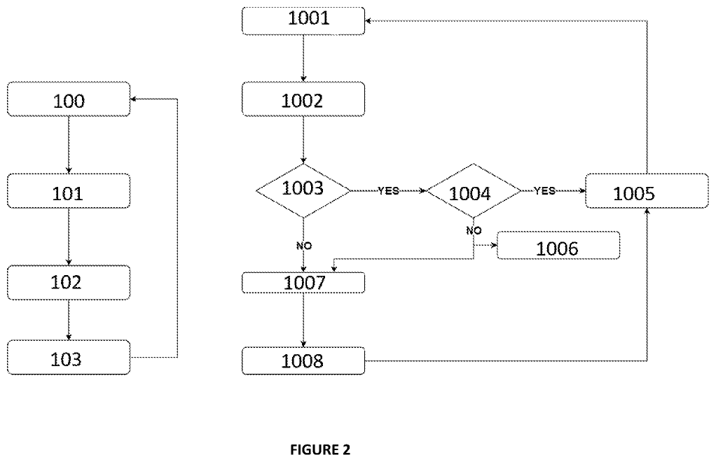

### REFERENCE NUMERALS

1. Application

2. Application Programming Interface Gateway

3. Microservices

4. Microservice Database

5. Cache System

6. Cache Updating Module
100. Reading the configuration file in the cache updating module.
101. Determining which cache value is updated asynchronously by means of the cache updating module.
102. Retrieving the updated data over related microservice by means of the cache updating module.
103. Transmitting the retrieved updated data to the cache system.
1001. Sending a request to the cache system in order to retrieve data from the application.
1002. Receiving all data incoming from the application by means of the application programming interface gateway.
1003. Controlling if there is data on the cache system.
1004. Controlling the validity period of the cached data by means of the cache updating module.
1005. Sending data with an ongoing validity period to the web application by retrieving the said data over the cache system.
1006. Discarding the data with an expired validity period from the cache system.
1007. Transmitting the request to the related microservice in case there is no data on the cache system.
1008. Retrieving the data requested from the microservice database by means of the cache updating module.

### DESCRIPTION OF THE INVENTION

The necessary information is retrieved from the server and added to the cache (especially when the system is not too busy) by means of predicting the operation to be performed before the system is used by a single user or many users having a certain predicted profile. Thus, asynchronous caching is performed via cache updating module (6) without any user request.

End-users may use the applications (1) faster and get a quick response since said users can receive the data over the cache system (5) at the initial request they made by means of the inventive system and the method.

The present invention comprises an application (1), an application programming interface gateway (2), microservices (3), a microservice database (4), a cache system (5), and a cache updating module (6).

Application (1) allows for displaying data to be retrieved by means of sending HTTP requests to the application programming interface gateway (2). HTTP requests allow for retrieving data from mobile/web applications (1). Said application (1) can work on one of many popular platforms such as web, mobile, desktop, computer, smart device, wearable device, etc. as well as the Internet of Things (IoT) devices.

The application programming interface gateway (2), also called API Gateway, functions as a bridge between Application (1) and microservices (3). Said API gateway (2) directs the request it is receiving from its applications (1) to the related microservice (3). Application programming interface gateway (2) controls whether the responses of the related requests are available on the cache system (5). The application programming interface gateway (2) ensures that the data is retrieved from the cache system (5) and communicated to the web application in case the data has been previously added to the cache system (5) and its life cycle had not expired.

Microservices (3) are the service architecture with limited areas of task and responsibility that are capable of performing only one task with all details thereof.

The microservice database (4) is a database in which the data of microservices (3) are stored. Additionally, there is a main data source. The main data source refers to a medium in which the data is maintained and served. Data on said medium is always up to date.

Cache System (5) ensures that the data on the cache system is updated by means of the cache updating module (6) by retrieving data over the main source when the system resources are consumed and new data generated at the main source. Thus, the user data that has changed on the main source can always remain up to date on the cache system (5).

The cache updating module (6) ensures that the data is retrieved from the respective microservice (3) independently of the applications (1) and that the cache system is continuously updated by writing said data on the cache system (5). The cache updating module (6) uses a method while performing the said operations and implements certain process steps during this method.

These process steps can be summarized as follows; first, the configuration file in the cache updating module (6) is read (100). Cache updating module (6) determines (101) which cache value is updated asynchronously. The updated data is retrieved (102) by means of cache updating module (6) over the relevant microservice (3). Retrieved up-to-date data is transmitted (103) to the cache system (5).

A set of process steps are also carried out while determining (101) which cache value is updated asynchronously by means of the cache updating module (6) and retrieving (102) updated data over the corresponding microservice (3) by means of the cache updating module (6).

Herein, a request is sent (1001) to the cache system (5) in order to retrieve data from the applications (1). All data obtained from the application (1) are received (1002) by the application programming interface gateway (2). Cache updating module (6) controls (1003) whether there is data on the cache system (5). In case data is detected as a result of the said controlling operation, the validity period of the cached data is controlled (1004) by means of the cache update module (6). Data with an ongoing validity period is sent (1005) to the application (1) after being retrieved over the cache system (5). Expired data is discarded (1006) from the cache system (5). In case there is no data on the cache system (5) the request is transmitted (1007) to the relevant microservice (3). Data requested from the microservice database (4) is retrieved (1008) by means of the cache updating module (6).

Data kept over the cache system (5) is deleted once its validity period is expired. Data is added to the cache system (5) after the new requests are being submitted to the server by the users. The cache updating module (6) analyzes those requests and the frequency thereof, and the data is cached without expecting requests from the users. There are two main approaches that are emphasized for the mentioned requests' analysis. These approaches are user-based approach and profile-based approach. The user-based approach involves making deductions for the future based on the predictions that are made on the basis of a user's previous requests, visits made in the application, times of the requests', and the visits'. For instance, the possibility of a user logging in the next Monday is taken into consideration for a user who wishes to learn the remaining data amount in its data plan every Monday via the application.

The profile-based approach analyzes the requests of the users having certain profiles (age, gender, location, etc.) in the application and makes various predictions. For example, if it is assumed that men between the ages of 18 and 25 living in Istanbul request to learn their “remaining data amount” every morning, said requests will be pre-cached for all of the users that are categorized in this profile.

The following method and process steps are carried out while the mentioned approaches are applied and analyzed by the cache update module (6). The cache updating module (6) performs caching as a result of the said process steps. Primarily, time groups are created at certain frequencies (for example, one group for every 24 hours). Each group will include 5 different sets. Said sets indicate the possibility of the login of a user at the respective time. Probability classes of the created sets are determined. These sets are classified as very high probability, high probability, moderate probability, low probability, and remote probability. Caching is performed according to the probability class. If it is highly likely for a user to log in at a specific time, then the necessary caching is performed accordingly. Similar patterns are created based on the time group set in which users of similar profiles use the system to be used in the profile-based approach, and the profiles are cached accordingly.

It is assumed that user activities continue infinitely in user-based approaches. Accordingly, a machine learning model is developed in order to predict the next step of the user. Said model predicts the next step of the user in any case. Model updates itself periodically to predict the next step of the users.

The present invention provides a solution to problems in which data is required to be retrieved from the main data source as the data in cache systems (5) is deleted after a certain period of time, and cached data may be retrieved in the second and the subsequent requests only. Thus, data can be read over the cache system (5) and the system can respond with high performance.

The asynchronous cache updating module (6) ensures that the data kept on the cache systems (5) is updated independently of the validity period thereof.

The inventive system ensures that the traffic to the servers in which the main data is maintained is controlled in a better, more efficient way. The present invention further ensures that servers may run with less hardware even during the periods in which system resources of the said servers are completely consumed since system resources would be used for updating the cache data.

1. (canceled)

2. A cache updating method that allows for updating data kept on the cache system (5) independently of the validity period of the data, characterized in that, it comprises the process steps of;
reading (100) the configuration file in the cache updating module (6);
determining (101) which cache value is updated asynchronously by means of the cache updating module (6);
sending (1001) a request to the cache system (5) to pull data from the applications (1);
receiving (1002) all data from applications (1) by the application programming interface gateway (2);
controlling (1003) whether there is data on the cache system (5) by means of the cache updating module (6);
controlling (1004) the validity period of the cache data by means of the cache updating module (6) in case data is detected as a result of the control;
retrieving the data, whose validity period is still valid, over the cache system (5) and sending (1005) these to the applications (1);
discarding (1006) the expired data from the cache system (5);
transmitting (1007) the request to the related microservice (3) in case there is no data on the cache system (5);
retrieving (1008) data requested from microservice database (4) by means of the cache updating module (6);
transmitting (103) the retrieved updated data to the cache system (5).

3-7. (canceled)

8. A cache updating method according to claim 1, it comprises a deep machine learning model in order to predict the next step of the user.

9. A cache updating method according to claim 1, characterized in that, the analysis method of cache updating module (6) comprises the process steps of;
Creating time groups at certain frequencies,
Creating sets that indicate the possibility of login of a plurality of users in the system at the respective time in each one of the groups,
Determining the probability categories of the created sets,
Performing the required caching according to the probability category of the user,
Creating similar patterns according to the set of time groups when users with similar profiles use the system and caching the profiles.

10. A cache updating method according to claim 9, characterized in that, the sets of probability categories are very high probability, high probability, moderate probability, low probability, and remote probability.

11. (canceled)

12. A cache updating method according to claim 1, characterized in that, the application (1) can be the Internet of Things (IoT) devices.

13. A cache updating method according to claim 1 or, characterized in that; platforms on which said application (1) runs on are web, mobile, desktop, computer, smart devices, wearable devices.
